(19) United States
(12) Patent Application Publication
(10) Pub. No.: US 2012/0092162 A1
(43) Pub. Date: Apr. 19, 2012

(54) INFECTIOUS DISEASE WARNING SYSTEM

(76) Inventor: Mitchell Chester Rosenberg, Cherry Hill, NJ (US)

(21) Appl. No.: 12/907,125

(22) Filed: Oct. 19, 2010

(51) Int. Cl. G08B 13/00; G08B 21/00

(52) U.S. Cl. 340/541; 340/540

(57) ABSTRACT

A system comprising a portable unit which can be temporarily placed outside a patient room comprising a processor, memory, a speaker or voice generator, and programming to allow an authorized user to select (A) a disease or medical condition which corresponds to preprogrammed simulated voice warnings, for example “wash hands,” “wear gown,” “wear gloves,” “wear mask,” “dispose of gown,” “use hand sanitizer,” “wash hands with soap and water after removing protective clothing,” and combinations of said voice warnings; or (B) one or more of said preprogrammed voice warnings; a room entry detector programmed to activate the simulated voice warnings, the system configured so that when entry to the room is detected, one or a combination of the simulated voice warnings is emitted by the system.

### BACKGROUND OF THE INVENTION

The present invention relates to the field of medical devices, more particularly to the field of contact isolation and infectious disease warning systems.

More than 90,000 Americans get life-threatening, invasive infections annually from the drug-resistant Staphylococcus “superbug”, Methicillin-resistant Staphylococcus aureus (MRSA), often in an institutional setting such as a hospital; these infections reach the bloodstream or destroy flesh and turn deadly. MRSA-related hospitalizations have increased by as much as 119% over three years according to some reports. Death rates average 1,000 per month. Clostridium difficile (C. diff) which is a highly contagious bacterium causing diarrhea, colitis, toxic megacolon, and colonic perforations can also be spread in hospital settings via fecal contamination of objects and surfaces. Death rates from this have been increasing dramatically in recent years as well. The fact that these and other organisms have mutated to become highly resistant to antibiotics makes them difficult to eradicate and thus a major initiative has been placed on preventing their spread. The mainstay of prevention is hygiene and contact isolation.

Other infectious agents are transmitted via airborne or droplet vectors and specific strategies are utilized to prevent their spread. At times, the hospital must arrange protective isolation for immuno-compromised patients.

Hospital patient rooms are generally open to visitors, medical and paramedical staff, and hospital employees, but when medically compromised patients occupy a hospital room, special precautions, following certain protocols which depend on the patient condition, must be taken to prevent transmitting disease to the patient or from the patient.

Warning visitors and staff of the precautions which must be taken regarding an individual patient under isolation has been a problem for hospitals. Due to the fact that hospitals are very busy places with many types of passive signs and other devices used for many purposes, it is not a rare occurrence for handwritten or even printed signs to be ignored or accidentally overlooked. Furthermore, placement of the sign can be ambiguous if the doors or entryways are adjacent with little space between them

A better, more active, yet inexpensive, solution to this problem is needed and it is an object of the present invention to provide a device and a corresponding method to address this problem.

### SUMMARY OF THE INVENTION

This object, and others which will become apparent from the following disclosure and accompanying drawings, are achieved by the present invention which comprises in one aspect a system comprising a processor, memory, a speaker or voice generator, and a set of programming instructions functioning to allow an authorized user to select (A) a disease, medical condition, or type of isolation which corresponds to preprogrammed simulated voice warnings; or (B) one or more preprogrammed voice warnings; a room entry detector programmed to activate the simulated voice warnings, the system configured so that when entry of the room is detected one or a combination of either (A) the one or more simulated voice warnings corresponding to the selected disease, medical condition, or type of isolation, or (B) the one or more selected voice warnings, is emitted by the system.

Examples of voice warnings are “wash hands,” “wear gown,” “wear gloves,” “wear mask,” “dispose of gown,” “use hand sanitizer,” “wash hands with soap and water after removing protective clothing,” and combinations of said voice warnings. Examples of additional voice warnings which can be programmed into the system are listed in Table 1.

In another aspect, the invention comprises a method of warning visitors and medical staff of a patient condition in a patient room comprising placing such a system outside the patient room and selecting a disease or medical condition of the patient, type of isolation, or one or more specific voice warnings. The system is programmed so that when a person is detected entering the patient room, one or a combination of the voice warnings is emitted by the voice generator or speaker. The particular voice warnings emitted by the voice generator or speaker are those which are preprogrammed to be emitted when a particular disease or medical condition of the patient or type of isolation is selected, or are one or more of a plurality of voice options which can be selected directly by an authorized user, for example a nurse.

The system can comprise a portable unit which can be temporarily placed outside a patient room, for example on a door, door jamb, or wall near the entrance to the room.

The invention is an improvement over existing systems since it is much more unlikely that a visitor to a room housing a patient with a contagious medical condition, or a immune-depressed medical condition, will unwittingly enter the room without proper precautions if the visitor is warned by an alarm system which emits voice warnings, especially if the voice warning is from a preprogrammed selectable set. Sophisticated airplane cockpit systems have in recent years included voice warnings, especially those simulating a female voice, for important events since it has been discovered that when pilots are very busy and in a rush, like hospital staff, they notice a female voice warning more readily than other types of alarms.

### BRIEF DESCRIPTION OF THE DRAWINGS

The description set forth above, as well as other objects, features and advantages of the present invention, will be more fully appreciated by referring to the detailed description and the drawings that follow.

FIG. 1 is a front perspective view of device according to the invention, showing a touch screen with a welcome message and a speaker.

FIG. 2 is a front perspective view of device according to the invention, showing a touch screen displaying a selectable list of types of precautions, and a speaker.

FIG. 3 is a front perspective view of device according to the invention, showing a touch screen displaying a selectable list of medical conditions, and a speaker.

FIG. 4 is a front perspective view of a device according to the invention, showing a touch screen displaying a selectable list of voice warnings, and a speaker.

### DETAILED DESCRIPTION OF THE PREFERRED EMBODIMENTS OF THE INVENTION

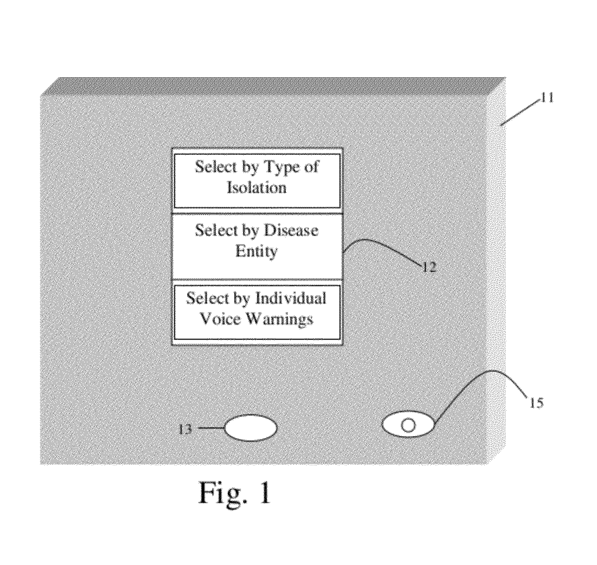

Reference is now made generally to FIG. 1 wherein one embodiment of a system according to the invention wherein a box 11 having a touch screen 12 which displays a welcome screen having three selection modes, “select by disease entity,” “select by type of isolation,” and “select by individual voice warnings.” The box 11 includes a processor and memory, and a sound generator which is capable of generating voice simulations, and a speaker 13 as well as the touch screen 12. The box also includes a motion detector or proximity detector 15. The motion or proximity detector can be adjusted with respect to sensitivity and other factors using the touch screen in setting mode, for example. The motion detector can be a smart detector so that it can distinguish between irrelevant events such as a person passing by a room and an actual person entering the patient room.

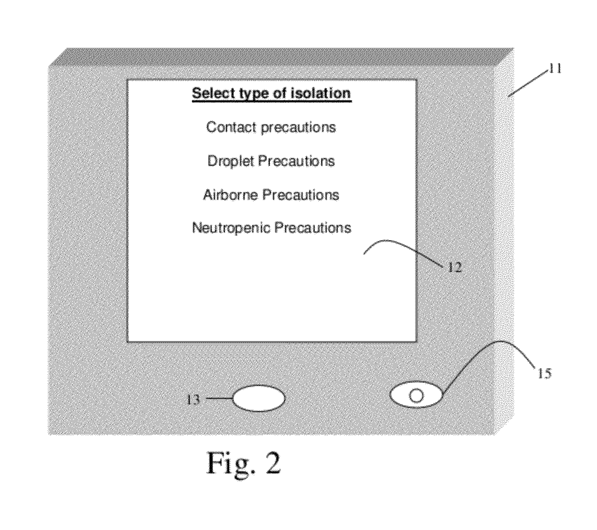

FIG. 2 illustrates the same device as the display would appear when Select by Type of Isolation is selected on the welcome screen.

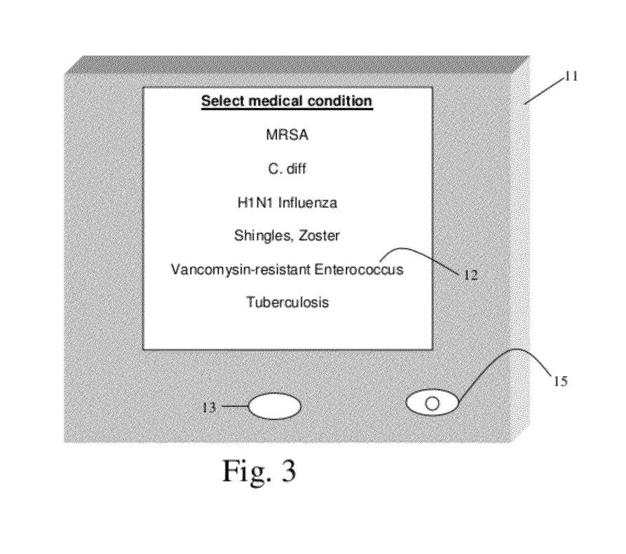

FIG. 3 illustrates the device of FIG. 1 as the display would appear when the Select by Medical Condition is touched on the welcome screen. An example of a set of voice warnings in one embodiment of the device include: “wash hands,” “wear gown,” “wear gloves,” “wear mask,” “dispose of gown,” “use hand sanitizer,” “wash hands with soap and water after removing protective clothing,” and combinations of said voice warnings.

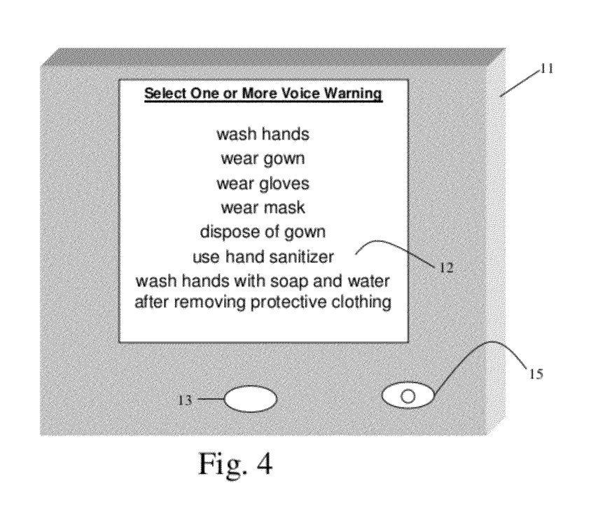

FIG. 4 illustrates the device of claim 1 as the display would appear when Select by Voice Warning is touched on the welcome screen.

Table 1 lists a more comprehensive list of possible voice warnings which can be preprogrammed in certain other embodiments of the invention.

TABLE 1
List of Voice Warnings

Wash hands before entering
Wash hands before contact
Wash hands before putting on gloves
Wash hands after contact
Wash hands before and after contact
Wash hands after removing gloves
Wash hands after leaving the room
Wash hands with soap and water
Wash hands with soap and water after removing gloves
The use of gowns, gloves and eye protection is based on the task
to be performed and the risk of exposure to blood and/or body fluids
Gowns, gloves and mask are to be worn for all patient contact and
to be donned before entering the room
Gowns and gloves are required for all entering
Gowns and gloves are required for all patient contact
Gowns and gloves are required for all environmental contact
Dispose of gown in room
Dispose of gloves in room
Dispose of gown after leaving room
Do not enter this room unless you are immune to Chicken Pox
Do not enter unless you are immune to Rubella also known as
German Measles
Do not enter this room unless you are immune to Rubeola
See nurse before entering this room
Susceptible persons may not enter this room
This is a negative pressure room
Keep door closed
Wear eye protection if splashing is likely
Wear mask
Wear mask if within 3 feet of patient
Wear N-95 mask or powered air respirator
Wear fitted TB mask or powered air respirator
Surgical masks and gloves required for all entering
Wear gown if contact with secretions possible
Do not enter if you have an active infection such as a sore throat,
fever, diarrhea etc.,
No children under 14 allowed
No fresh flowers or plants permitted
Wear gown if contamination of visitor or caregiver is anticipated
Use dedicated patient equipment
Do not enter, see nurse

In Table 2, an example is shown of a set of simulated voice warning announcements which are automatically made by the device when certain medical conditions are selected by the nurse or other professional staff and the motion detector detects a person entering the room.

TABLE 2
Voice Warnings By Medical Condition

| Medical Condition | Synthetic Voice Warning |
|---|---|
| MRSA | Gowns and gloves are required for all entering, wash hands before and |
| | after contact, wash hands after removing gloves, dispose of gown and |
| | gloves in room, wear eye protection if splashing is likely, use dedicated |
| | patient equipment |
| C. diff | Gowns and gloves are required for all entering, wash hands before and |
| | after contact, wash hands with soap and water after removing gloves, |
| | dispose of gown and gloves in room, wear eye protection if splashing is |
| | likely, use dedicated patient equipment |
| Vancomycin- | Gowns and gloves are required for all entering, wash hands before and |
| resistant | after contact, wash hands after removing gloves, dispose of gown and |
| Enterococcus | gloves in room, wear eye protection if splashing is likely |
| Klebsiella | Gowns and gloves for all entering, wash hands before and after contact, |
| pneumonia | wash hands after removing gloves, dispose of gown and gloves in room, |
| | wear eye protection if splashing is likely, use dedicated patient equipment |
| H1N1 Influenza | Wear mask if within 3 feet of patient, wear N-95 mask or powered air |
| | respirator, gowns and gloves are required for all entering |
| Tuberculosis | This is a negative pressure room, wash hands before entering the room and |
| | after removing gloves, wear fitted TB mask or powered air respirator, wear |
| | gloves if contact possible with blood or body fluids, gowns are required if |
| | contamination of clothing is possible either by blood or body fluids or a |
| | contaminated environment, keep door closed. |
| Shingles, Zoster | Gowns and gloves for all entering, wash hands before and after contact, |
| | wash hands after removing gloves, dispose of gown and gloves in room, |
| | wear eye protection if splashing is likely, do not enter this room unless you |
| | are immune to Chicken Pox |

Upon selection of a medical condition, e.g., C. diff., the system automatically determines the selection of appropriate voice warnings but would not announce or display the disease or medical condition, e.g., C. diff., due to privacy concerns.

In some embodiments an authorized user such as a nurse has an option to select a type of isolation, in which case the preprogrammed voice warning corresponding to that type of isolation are emitted by the device upon detection of a person entering the room of the patient. Table 3 lists some examples of possible voice warnings corresponding to such types of isolation.

TABLE 3
Voice Warnings by Type of Isolation

| Type of | |
|---|---|
| Isolation | Voice Warning |
| Standard | wash hands before and after contact; the use of gowns, |
| Precautions | gloves and eye protection is based on the task to be |
| | performed and the risk of exposure to blood and/or body |
| | fluids. |
| Contact | Wear gowns, wear gloves, wash hands before and after |
| Precautions | removing gloves, wear mask if splashing of body fluids is |
| | possible |
| Airborne | This is a negative pressure room, wash hands before |
| Precautions | entering the room and after removing gloves, wear mask, |
| | wear gloves if contact possible with blood or body fluids, |
| | gowns are required if contamination of clothing is |
| | possible either by blood or body fluids or a contaminated |
| | environment, keep door closed. |
| Droplet | Surgical masks and gloves required for all entering, keep |
| Precautions | door closed, wear gown if contact with secretions |
| | possible, wash hands before and after patient contact, keep |
| | door closed. |
| Neutropenic | Do not enter if you have an active infection such as a sore |
| Precautions | throat, fever, diarrhea etc., no children under 14 allowed, |
| | wear gloves, wash hands before and after contact, no fresh |
| | flowers or plants permitted, wear gown if contamination |
| | of visitor or care giver is anticipated |

The device of the invention can be self-contained or can be part of another device or system. The programming can take place at the device, for example by a nurse selecting warnings as one would select from a menu of options on a dishwasher, washing machine, or dryer, or can take place at a nursing console or even remotely by a hospital administrator who oversees many rooms. The set of instructions which constitute the programming can be in C++ or any of a variety of programming languages, and would normally be programmed into the processor. The simulated voice messages can be recorded by a person or can be synthesized from a dictionary of words or sounds.

A manual override can be provided which allows a nurse or other frequent (and educated) visitors to the room to suppress the voice warning on a one time or as needed basis if it becomes annoying.

The device can be temporarily placed on a door jamb, door, or wall at or near the entrance of a patient room in some embodiments. The device can also be permanently placed on or in a door jamb, door, or wall. The device will also include in most embodiments a motion detector 15 for detecting the approach of a visitor to the patient's room. The motion detector is preferably focused so that it has a narrow field of view, for example a 15 degree field of view, and can be a passive infrared (PIR) type set to detect a person at 10 to 15 feet, or a laser or IR beam sensor of conventional or specialized type. The device may be placed at a location and configured such that the motion detector would not activate the alarm if a person is passing by but not entering the room, or may include hardware and software to determine whether a person detected by the motion detector is the patient or a nurse for whom the warning is not necessary or is undesirable. The motion detector function of the device may be adjustable so that higher or lower sensitivity may selected so that the alarm functions when people are entering the room but not when they are passing by the room.

The device can be programmed to allow selection of one or more languages, for example in certain institutions both English and Spanish language announcements should be made whereas in other institutions announcements in both English and French or another commonly used language should be made.

The device can also include, in some embodiments, a touch pad and programming to request a password, and to indicate successful activation.

The device may also include a visual warning such as flashing lights or a flashing sign such as “contact isolation, see nurse” which will flash when a visitor is detected entering the room.

The device may include a selection option on a touchpad to toggle between “select voice warning message,” “select disease or medical condition,” and “select type of isolation: modes.

The system and method of the invention are well adapted to solve a serious problem in hospitals and other institutions where patients may have diseases which require special precautions on those entering the patient's room to protect those entering and the patient wherein the state of the art is to post a sign indicating the precautions to be taken, and wherein such signs are often unnoticed. This invention provides an easily and quickly programmable system which allows selection of a disease or condition or type of isolation by an authorized person, wherein the selection of disease is not announced to those entering the room and thus complying with privacy requirements, and wherein a voice announcement of precautions to take is calculated from the disease, medical condition, or type of isolation, and wherein such voice announcement is automatically made when the system detects a person entering the patient room.

Though the invention has been described with respect to a number of embodiments, many additional variations and modifications will immediately become apparent to those skilled in the art. It is therefore the intention that the appended claims be interpreted as broadly as possible in view of the prior art to include all such variations and modifications.

What is claimed is:

1. A system comprising a processor, memory, a speaker or voice generator, and a set of programming instructions functioning to allow an authorized user to select (A) a disease, medical condition, or type of isolation which corresponds to preprogrammed simulated voice warnings; or (B) one or more preprogrammed voice warnings; a room entry detector programmed to activate the simulated voice warnings, the system configured so that when entry of the room is detected, one or a combination of either (A) the one or more simulated voice warnings corresponding to the selected disease, medical condition, or type of isolation, or (B) the one or more selected voice warnings, is emitted by the system.

2. The system of claim 1 wherein the voice warnings are selected from “wash hands,” “wear gown,” “wear gloves,” “wear mask,” “dispose of gown,” “wash hands after removing protective clothing,” and combinations of said voice warnings.

3. The system of claim 1 comprising a portable unit which can be temporarily placed outside a patient room on a door jamb, door, or wall at or near the entrance of a patient room.

4. The system of claim 1 further including a touch pad and programming to request a password, display a plurality of selectable medical conditions, and to indicate successful activation.

5. The system of claim 1 further including a visual warning.

6. The system of claim 1 further including a motion detector module for determining when a person is entering a patient room.

7. The system of claim 1 further including means to select one or more languages for simulated voice announcements.

8. A method of warning visitors and medical staff of a patient condition in a patient room comprising placing a unit according to claim 1 outside the patient room and selecting a medical condition of the patient so that when a person is detected entering the patient room, one or a combination of the voice warnings is emitted by the voice generator or speaker.
